(19) United States
(12) Patent Application Publication
(10) Pub. No.: US 2015/0029336 A1
(43) Pub. Date: Jan. 29, 2015

(54) DIGITAL VIDEO RECORDER

(71) Applicant: DMITRY KUCHERYUK, SINGAPORE (SG)

(72) Inventor: DMITRY KUCHERYUK, SINGAPORE (SG)

(21) Appl. No.: 14/108,608

(22) Filed: Dec. 17, 2013

(30) Foreign Application Priority Data
Jul. 23, 2013 (SG) 201305670-0

(51) Int. Cl. H04N 7/18

(52) U.S. Cl. CPC H04N 7/183
USPC 348/148

(57) ABSTRACT

A video recorder mounted on a car windscreen. Sidewalls of a housing form an enclosed internal cavity housing a video camera. One sidewall of the housing is substantially flat, providing a fastening side for mounting the housing to the windscreen either directly or through a gasket, or through a gasket with a firm plate for forming a detachable fixation of the recorder to the windscreen. The housing fastening side, the gasket and the plate each have an opening of the same form and arrangement as the window. An optical axis of a video camera lens is directed through the cavity to the window, wherein an external radiation passing into the cavity and falling on the lens can be acquired by a camera image sensor for obtaining an image. Such a construction avoiding stray external light sources hitting the lens and avoids distortion of the received image from the external sources.

### CROSS-REFERENCE TO RELATED APPLICATION

The instant application claims priority to Singapore Patent Application Serial No. 201305670-0 filed Jul. 23, 2013, pending, the entire specification of which is expressly incorporated herein by reference.

### FIELD OF INVENTION

The present application relates to a video recorder apparatus. More particularly, the invention relates to car digital video recorder possessing features for reducing degradation of captured video or image quality caused by stray optical radiation incident onto the image sensor of the video recorder.

### BACKGROUND OF THE INVENTION

Currently, car digital video recorders (car DVRs) are widely used for observation and registration of events occurring around a vehicle where the recorder is installed. Such devices allow recording both video and audio information related to the situation around the car regardless of the moving or stationary condition of the car. The recorded information can be useful in resolving disputes related to road and transport incidents. Although commonly known car video recorders are used for recording incidents outside the car, they can be also applied for recording information about conditions within the car if they are properly oriented within the car interior. The digital video recorder equipped with the versatile mounting mechanism can be installed not only in cars, but also in tracks, water vehicles, and other vehicles. Almost all car video recorders can work both with monochrome and with color video images.

Currently, car video recorders are widely available in the market and are produced by many companies, for example, DOD, MIO, AKENORI, PAPAGO, etc.

Usually, car video recorders are mounted in the front part of the car salon, often on the windscreen, on a rear-view mirror or on the top of the dashboard in the car salon, to provide sufficient forward view for the car video recorder. Mounting the video recorder is performed by means of one or several suckers attached to a support, or by using an adhesive applied on a flat surface of the support for fastening to the windscreen or dashboard. An element in the form of an arm is usually joined with the support, to which arm the housing of the video camera itself is attached by means of a universal hinged connection.

U.S. Pat. No. 6,389,340 discloses a vehicle-mounted video recorder in which the mounting mechanism is composed of a pair of suction cups. The vehicle video recorder mounted onto the windscreen using foam adhesive can be found in the U.S. Pat. No. 7,893,958. Integrated systems having both rear mirror and video recorder are set forth in U.S. Pat. Nos. 5,096,287 and 8,309,907.

The car video recorder comprises a video camera directed outwards of the car salon, and a display facing inward the car interior, for example, towards the car driver. The display serves for representing information transmitted from the video camera or from the storage device of the video recorder. The display, if it is a sensitive one, can contain controls for controlling the video recording operation, or such controls can be located on a display housing along the edges of display area of the display. Such construction of housings of the video recorders enables rotation of the video camera and the display by means of hinged connection in any desired direction.

The general feature of the known car video recorders is the manner by which the video camera and/or its optical elements are arranged with respect to a camera housing and a windscreen aiming to provide clear video recording free from any visual hindrance. Because the video camera or its optical elements should be positioned so that video camera fixture does not impede observation, a field of vision of the video camera usually is directed away from the fixture and away from the housing of the video recorder.

However, in this case, the stray light rays reflected from the windscreen and impinging onto the optical elements (lens) of the camera tend to produce light patches on the image captured by the camera which leads to occurrence of artifacts in the image. If the artifacts are imposed on the important part(s) of the image, they may make the whole image or its some areas useless for identification purposes and resolving disputes in view of overlapping a part of image, and hence, the car video recorder fails to perform its designated task.

Specifically, such stray light patches impede video recorder work at night when light from sources external to the video recorder, for example, light of headlights of overtaking cars, light from the luminous screen of a mobile phone in hands of a driver or a passenger in the vehicle, light from street lights, etc., being reflected from the windscreen, gets to the video camera lens. Thus, during night-time such patches of stray light do not allow the clear video image of environment outside the car to be obtained. Therefore, it is deemed that the above mentioned devices are inadequate for providing desired recorded information during night time.

Also, at the car salon there can be dust and water steams which, if they get on the camera lens, can deteriorate the image quality. Thus, there are situations when extraneous influences in the form of rays of light, dust, fog and the like prevent receipting by the car video recorder a valid picture due to distortion of the image received by the video recorder. Images captured or recorded in such way can be significantly distorted in the presence of these extraneous influences. Consequently, a video recorder, in particular, car video recorder capable of resolving the shortcomings highlighted in the foregoing is highly desired. The present invention has been made with the aforementioned limitations in mind and is intended to overcome the vast majority of them.

### SUMMARY OF THE INVENTION

In order to overcome the aforementioned drawbacks, a digital video recorder which is detachably fastened on a car windscreen or a glass pane is provided. The digital video recorder is configured to counteract on artifact formation on the captured image or video as a result of strayed light or optical radiation fallen onto the sensor of the video camera. More specifically, the disclosed digital video recorder possesses uniquely fabricated housing configured to substantially eliminate the likelihood of strayed optical radiation from entering the optical elements of the camera to create artifacts on images captured by the camera. The housing is also serves as a support for the video camera.

In order to attain the mentioned objects, the video recorder has a housing enclosing a cavity by side walls covering a video camera placed inside the cavity. One of side walls, a front side, of the housing is substantially flat and is referred to as the fastening side. The housing is configured to removable attach onto a car windscreen or a glass pane by means of the fastening side. The fastening side of the housing has a window of arbitrary form, the housing window may be closed by a panel fabricated from a transparent material, or left open. The video camera positioned within the cavity has optical elements, such as a lens, oriented inward the housing in direction toward the window such that external radiation, for example, visible light, passes from outside the housing through the window only, gets to the video camera lens, and then falls to a camera image sensor which generates an image signal on the basis of the radiation. Thus, the video camera carries out acquiring the external radiation, obtaining an image, and recording the image on a storage medium or transmitting the image to a display of the video recorder.

In the embodiments of the invention, there are means providing detachable or fixed fastening of the video recorder to the car windscreen or a glass pane.

In one embodiment, a layer of adhesive substance applied on external surface of the fastening side may serve as such means, the adhesive substance possessing such adhesion ability to the windscreen that allows reliable holding the video recorder in its attached state to the windscreen or glass pane. Nevertheless, the adhesive substance provides a possibility to detach the video recorder from the windscreen or glass pane by applying sufficient force to the housing for detaching.

In other embodiments such means is a gasket on which opposite surfaces the adhesive substances are applied, one surface is for fastening the gasket to the housing fastening side, another one is for fastening to the car windscreen or glass pane.

In another embodiment such means, additionally to the gasket, comprises a metal or plastic rigid plate having the form preferably coinciding with the form of the fastening side of the housing, wherein the plate realizes the seamless engagement with housing and is positioned between the housing fastening side and the windscreen. The abovementioned gasket is fastened to one surface of the plate by means of adhesive substance. Another surface of the plate has a means, such as a locking profile, for detachable fastening with the corresponding counterpart locking profile located on the housing. The locking profiles are provided in the form of a male locking profile on the plate and a female locking profile on the housing, or vice versa, to detachably lock with each other to attach the housing onto the plate, and to the windscreen through the gasket.

By means of such structure an increased possibility of removal of the video recorder from the windscreen or glass pane is provided.

The plate and gasket, if they are present, each has an opening of the form substantially coinciding with that of the window in the housing fastening side. The window in the fastening side of the housing, the opening in the gasket and the opening in the plate each is surrounded by the closed surface of the fastening side, gasket or plate, respectively.

Thus, the video recorder may be fastened to the windscreen or a glass pane either directly or indirectly.

To further improve usability of the disclosed car video recorder, its housing may be hingeably secured to the plate and being enabled to throw open the housing from a first position, in the immediate contact to the plate, to a second position, which is 90 to 240 degree different from the first position to capture information inside the car saloon.

Still, in another embodiment, the cavity is substantially hermetic against smoke, water vapor and/or dust upon mounting the housing onto the windscreen to reduce the likelihood of the quality of the captured information being jeopardized by these external agents.

Such construction of the video recorder allows to block optical radiation derived from backside and/or underside of the housing being reflected onto an area of the windscreen directly facing the window and, thus, to avoid distortion of the captured image by light patches from the stray external sources.

### BRIEF DESCRIPTION OF DRAWINGS

FIG. 1 is a schematic illustration of one embodiment of the disclosed car video recorder with a display, according to the present invention;

FIG. 2 represents a perspective view of the housing of the car video recorder, as illustrated in FIG. 1, showing the fastening side of the housing, according to one embodiment of the present invention;

FIG. 3 illustrates a perspective view of the car video recorder, as illustrated in FIG. 1, mounted onto a windscreen or a glass pane with exploded view, according to one embodiment of the present invention;

FIG. 4a-4c illustrate several cross-sections through the housing of the car video recorder, as illustrated in FIG. 1, and the car windscreen according to one embodiment of the present invention;

FIG. 5 illustrates a first alternative housing of the car video recorder, according to a first alternative embodiment of the present invention; and

FIG. 6 illustrates a second alternative housing of the car video recorder, according to a second alternative embodiment of the present invention.

### DETAILED DESCRIPTION OF THE INVENTION

One skilled in the art will readily appreciate that the present invention is well adapted to carry out the objects and obtain the mentioned advantages, as well as those inherent therein. The embodiments described below are not intended to be considered as limitations of the scope of the invention. The embodiments disclosed in the disclosure may be combined with each other in any form without departing from the scope of the present invention.

In the description below the terms “video recorder,” “car video recorder,” “video recorder apparatus” and “car digital video recorder” denote the same and are used interchangeably.

The terms “camera” and “video camera” denote the same are used interchangeably.

The terms “optical elements” used herein throughout of the specification refers to such components of the video camera as a lens responsible for directing the optical radiation to image sensor of the camera for providing the sensor with a possibility to generate, from the forwarded optical radiation, digitized images of the events happened around.

The terms “strayed optical radiation,” and “stray light” used interchangeably herein throughout the specification refer to optical radiation bringing into contact, by either refraction or reflection with the optical elements of the camera out of the defined field of vision or angle of view of the camera. The strayed optical radiation may create, but not necessary, deceptive illusions or parasitic images onto the recorded information or create light patches on the image captured by the camera which lead to occurrence of undesired artifacts in the image.

The video recorder may be accommodated to be mounted to a windscreen or any glass pane, and in the present specification the terms “windscreen” and “glass pane” are used interchangeably. However, for the purposes of simplicity only, the following description is provided with respect to the windscreen.

The main parts of a car digital video recorder are a video camera, a control and processing block, a storage and a display.

Video camera of the present invention consists of various electronic and optical components known in the art to digitally generate, record and/or transmit the captured information. The components required to implement the video camera may include a flexible integrated circuit board, computing processor, RAM, digital writing and storage medium, optical (image) sensor, optical lens, and the like. It is possible to accommodate the assembly of video camera partially or wholly inside the housing according to different embodiments provided in the present invention. The camera through its optical elements (objective, lens) acquires external radiation falling on the image sensor, generates a video signal (video image) which is transferred to the control and processing block. The video camera of the disclosed video recorder may be equipped with a communication module for receiving/transmitting digital information from/to the control and processing block if it is arranged out of the housing of the video recorder.

The control and processing block performs controlling operations of the video recorder, processes the video image acquired by the video camera and generated by its image sensor, may perform compression of the video image for reducing data volume, and transfers the obtained data to the storage for recording to it and/or to a video display. Usually, the storage is of electronic or magnetic type, such as flash-memory, a hard disk or an optical disk and the like, as well known to those skilled in the art.

The display reproduces the image transferred to it from the video camera directly or read out from the storage device. Controls for controlling the operation of the video recorder may be positioned on the display, if the display is of touch-screen type, on the video recorder housing near the display area or may be arranged in the control and processing block. The display may be attached to the housing and be arranged above, below or sideways from the housing. Fixation of the display to the video recorder housing, for example, may provide a possibility of rotation of the display around a vertical axis, if the display is fastened sideways from the housing, or around a horizontal axis, if the display is fastened above or below the housing. Other commonly known kind of attaching the display to the housing should be apparent to a skilled person. Moreover, the display may also be detachable or be fully separated from the video recorder housing. Communications between the display and the video camera and/or the control and processing block are implemented either by wire or wirelessly or by combination thereof.

The car digital video recorder according to the present invention is described below with references to figures, where similar reference positions denote similar elements. It should be noted, that the figures illustrate the video recorder not in the scale.

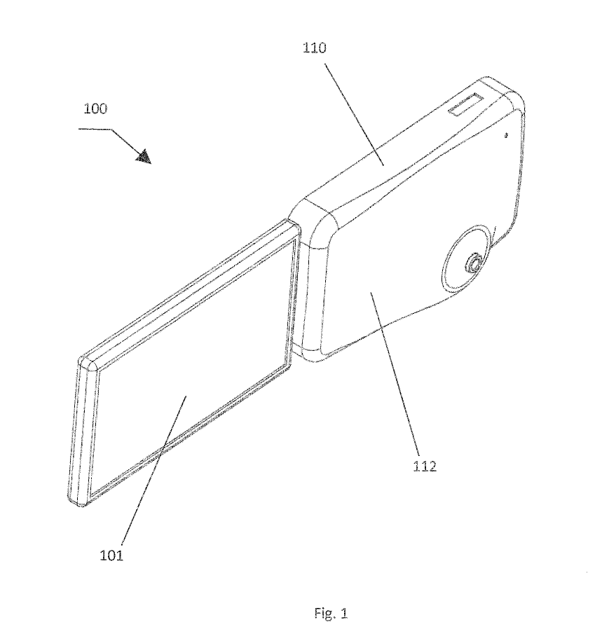

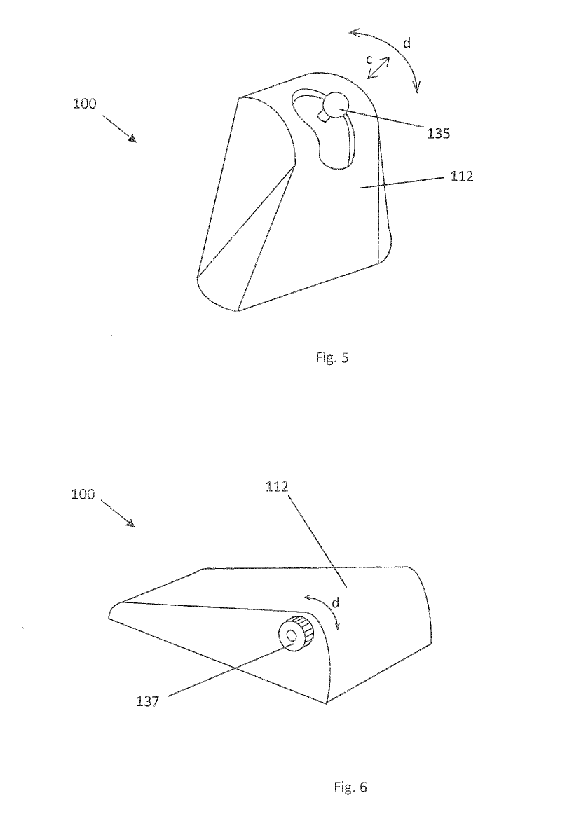

In FIG. 1, an example of a general view of the video recorder (100) which has a housing (110) and a display (101) is illustrated. In one embodiment, the housing has a form of parallelepiped with the rounded off corners and the rounded off edges between sidewalls (facets). However, the video recorder housing may have various forms, for example, rectangular in the plan, oval in the plan, the irregular form, etc. Several possible appearances of the video recorder housing form are provided in FIGS. 5 and 6. The general requirement to the housing is isolating its internal space from stray external light, moisture, dust, etc. and presence of a window only through which the external “useful” radiation can get to the housing interior and hit in the video camera lens.

In the embodiment, where the housing is of parallelepiped form, the size of front side of the housing in any one dimension may be within the range of about 25-150 mm, preferable about 30-70 mm, while the housing thickness is about 4-60 mm, preferable about 10-25 mm. It shall be noted that the sizes of the housing are not limited by the cited numerical values which are presented as examples only and may be set individually, in appropriate manner for each particular realization of the video recorder. Therefore, the indicated sizes in practical realizations may be more or less than are presented above.

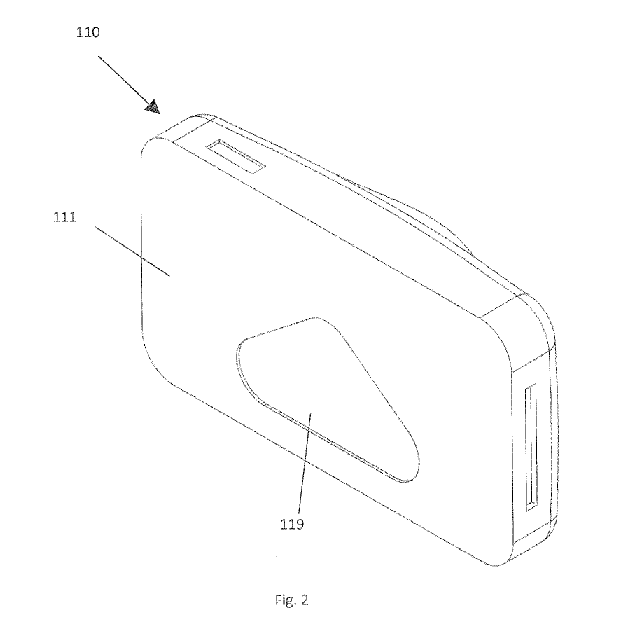

With reference to FIG. 2, the car video recorder (100) is shown having the housing (110). Preferably, the housing (110) is fabricated from plastic, metal or alloy material with good mechanical strength properties. Regardless of the material, the housing shall not significantly affect the overall weight of the video recorder to ensure the video recorder is light enough to be attached onto the windscreen or a glass pane without much difficulty and have mechanical strength sufficient to provide integrity of the housing while being detached from the windscreen.

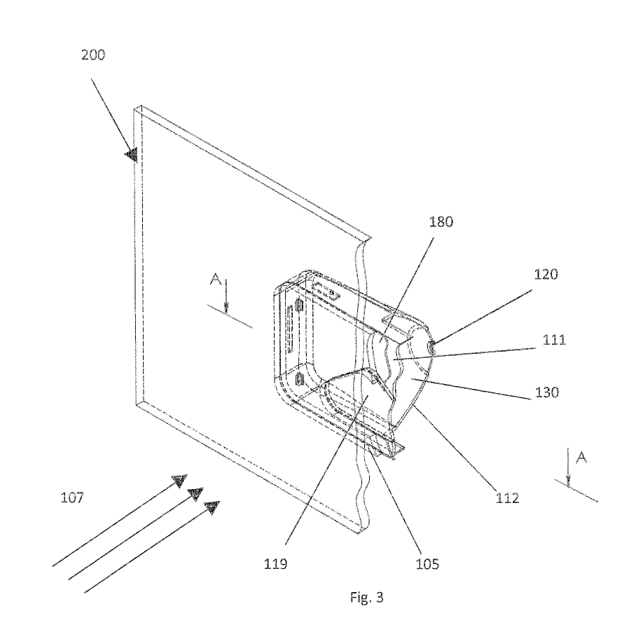

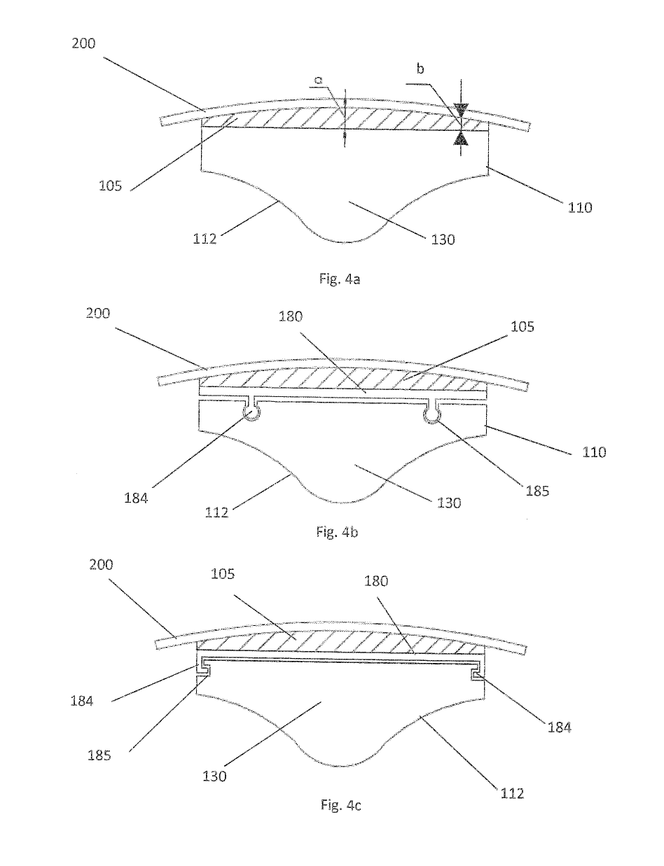

The housing (110) by its sidewalls, including a front side (111) and a back side (112) being at least partially spaced apart at a predetermined distance, defines an enclosed cavity (130) as illustrated in FIGS. 3 and 4, for accommodating therein the video camera and, in some embodiments, the control and processing block.

In general, the front side and the back side are not identical in shape. The back side of the housing may be convex (as shown in FIGS. 1, 4, 5, and 6). In contrast, the front side is substantially flat, and with help of the flat surface of the front side the video recorder may be fastened to the windscreen directly or by additional means. This front side having a substantially flat surface in the present description is also referred to in the description as the fastening side for mounting video recorder housing to the windscreen. The fastening side is designated by a reference position (111) in the figures. It should be noted that the fastening side is not indicated in FIGS. 5 and 6.

The convex shape of the back side significantly increases the volume of the defined cavity allowing more components to be accommodating therein. The convex configuration of the back side also creates greater distance in between the front side and at least a part of the back side providing greater flexibility for the disclosed video recorder to adjust the relative position of the optical elements of the video camera within the housing to ensure, for example, the optimal field of vision. The fastening side (111) of the housing has a window (119) of arbitrary form and in some embodiments is closed by a panel from a transparent material, which is flush with the surface of the fastening side. Preferably, the form of the window is a rectangular occupying as much surface area of the fastening side as possible. In other embodiment the window can be left open, thus creating an opening. Nevertheless, in some embodiments, the window (119) in the fastening side (111) of the housing is encompassed by a closed surface of the fastening side.

The external optical radiation denoted in FIG. 3 as (107), for example, visible light or IR-radiation passes into the housing through the window only and falls into the optical elements of the video camera. It is important to be noted herein that the present invention requires that at least the optical elements of the video camera to be installed within the defined enclosed cavity (130) of the housing (110) and to be protected from entering of the strayed optical radiation inside the housing by the housing sidewalls. Accordingly, optical elements of the camera are arranged to receive optical radiation passing sole through the formed window (119) on the fastening side (111) of the housing and the windscreen (200) to finally land on the optical elements (lens) of the video camera only.

The internal surface of the cavity may be covered with non-reflective paint or non-reflective material. The non-reflective coating absorbs optical radiation entering the cavity through the window and bringing into contact with the internal surface without being reflected inside the cavity. The non-reflective coating further negates unwanted light or optical radiation reflection within the cavity.

In some embodiments the video recorder has, between the windscreen or a glass pane and the flat surface of the front side of the video recorder housing, a means for mounting the video recorder to the windscreen in detachable manner.

In one embodiment such means is represented by a gasket (105) in form of pliable sheet from elastic (resilient) material, such as rubber or foamed material. The gasket also has an opening with the form and arrangement substantially coinciding with the form and arrangement of the window (119) in the fastening side (111) of the housing (see FIG. 3). Although FIG. 3 shows that the gasket opening has the same size as the window (119) in the fastening side, the gasket opening can be cut off in order to have a some larger size, for example, by 1-3 mm in each direction along the window (opening) plane, so as not to prevent the external radiation inclined under some angle to the lens axis for falling onto the video camera optical elements within the housing.

The gasket has two opposing planar surfaces coated with adhesives to detachably fix on the windscreen and the fastening side of the housing, respectively. A layer of a first adhesive substance for providing attachment of the gasket to the fastening side (111) of the housing of the video recorder is applied on the one planar surface of the gasket (105). A layer of the second adhesive substance is applied on another planar surface, opposite to the first one, of the gasket for fastening the gasket to the windscreen. The first adhesive substance and the second adhesive substance can be differing from each other or identical.

Thus, the housing (110) of the video recorder by its fastening side (111) is fastened to the windscreen by means of the intermediate gasket (105) on which planar surfaces the first and the second adhesive substances are applied.

The chemical formulation of the first adhesive substance and the second adhesive substance are not a subject of the present invention. The basic requirement for the adhering properties of these substances consists in that they should hold the weight of the whole recorder in its mounted-to-the-windscreen state without additional assistance of, for example, mechanical, supporting means, i.e., fastening strength of one adhesive substance, applied onto one surface of the gasket, with the windscreen and fastening strength of another adhesive substance, applied onto another surface of the gasket, with the housing should allow to maintain the video recorder in its mounted (operating) state.

It is preferred that the second adhesive leaves no residues on the windscreen after detachment of the disclosed video recorder from the windscreen.

Other requirements for the properties of adhesive substances can be transparency, non-toxicity, preservation of adhesion properties for a long time, etc.

The gasket (105) of an elastic material is described referring to FIG. 4a, where the sectional view along line A-A (shown in FIG. 3) through the housing of the video recorder attached in its mounted operating state to the windscreen is illustrated. The windscreen can have a small curvature which is given while manufacturing the windscreen for the purpose of providing aerodynamic properties to the moving car. This curvature might not provide to the flat fastening side of the video recorder housing a possibility to be in close contact with the windscreen over the whole surface area of the fastening side. In one embodiment, pliability of the gasket inserted between the windscreen and the housing allows the housing to universally fix onto windscreen of various dimension and curvature and therefore allows for the elimination of this drawback since, owing to its elastic properties, in the mounted state of the video recorder to the windscreen a middle part and edge parts of the gasket have different degree of compression (designated as a and b in FIG. 4) to conform the curvature of the windscreen. The thickness of the gasket (105) may be from within 1 to 8 mm, preferable within the range of 2 to 4 mm. Although in FIG. 4 the sectional views of the video recorder are shown along the line A-A directed horizontally, it should be apparent that the conformation remains consistent across the gasket (105) along any another direction. Thus, the gasket shall have the cross-section providing close contact of the housing with the windscreen.

According to another preferable embodiment of the present invention, the fastening side of the housing of the video recorder has the form conforming to the windscreen curvature. In this embodiment, the gasket may not be required, and one adhesive substance for applying on the fastening side (111) of the housing for attaching the video recorder directly to the windscreen is required only. Requirements of properties of this adhesive substance are similar to those described above.

According to one more preferable embodiment of the present invention, the means for mounting the video recorder to the windscreen may be the gasket (105) in combination with a plate (180) having a form in a plan view preferably coinciding with the form of the fastening side in a plan view. The plate is physically rigid and is made from plastic, metal, etc. and also has an opening in the form and arrangement substantially coinciding with those of the window in the housing fastening side. The plate has two opposing planar surfaces on one of which is attached the gasket with the adhesives, to fix onto the windscreen, and another planar surface of the plate is provided with a first locking profile. In this case the housing has the counterpart locking profile being fashioned to detachably interlock with the first locking profile to mount the housing to the plate in the male-female locking manner. The thickness of the plate is within the range from 1 to 8 mm, however, any other values for the thickness may be used.

The mentioned structure is illustrated in more detail in FIGS. 4b and 4c.

FIG. 4b shows the plate (180) having two opposing planar surfaces, one fabricated with a pair of male locking profile (184) and another fixed to the gasket (105) fastened to the windscreen. The male locking profile (184) in FIG. 4b in this embodiment is at least one pair ball structures. Each ball structure has one side integrated with the plate planar surface. Correspondingly, the pair of compatible spherical hollows which serve as the female locking profile (185), is engraved at the fastening side (111) of the housing (110). Each hollow has opening slightly smaller than the diameter of the ball structures. The ball structures preferably possesses good elasticity which allows the ball structure to be temporarily deformed while being inserted into or removed out of the holes through the smaller opening. More preferably, the spherical hollow may be slightly smaller in size than the ball structure to facilitate snug engagement of the male (184) and female locking profiles (185). Such fastening should provide reliable fixing of the video recorder in its operating state to the windscreen without self-detaching.

In one more embodiment, the ball structures are replaced by at least one pair of parallel ridges extending longitudinally on the plate (180), and the fastening side (111) has corresponding pair(s) of corresponding grooves to slidably interlock with the ridges. The ridges should not be necessarily having a round cross-section, they might be in L-form or any another form which allows tight attachment of the housing (110) to the plate (180). FIG. 4b can be considered as a cross-section of such ridges/grooves. A further embodiment illustrated in FIG. 4c, wherein the plate (180) has two L-shaped opposing lateral latches, as the male locking profile (184), to be slidably engaged by compatible protrusions with two opposing grooves, as the female locking profile (185), located on the fastening side (111) of the housing (110). As a result of the sliding, the fastening side window matches the plate opening for the realization of mounting the housing for the operation of the disclosed video recorder (100).

When fixing the plate (180) with the housing (110) is made by the lateral latches entering into corresponding grooves in the housing thus allowing to fix the housing (110) to the plate (180), the detachment of the housing from the plate is performed by bending back the lateral latches.

In a further embodiment, the means for fixing the plate (180) to the housing (110) of the video recorder, instead of several elements of the male locking profile, may have the male locking profile in the form of single continuous ridge extending along all periphery edge of the plate (180). The mentioned ridge engaging with a counterpart groove similarly extending along all periphery of the housing. In such case the plate with the ridge may be considered as a “basin” for inserting the housing by its grooves into it, and the material of the ridge should have corresponding elastic properties allowing unbending the ridge for inserting in and removing the housing into/from the “basin.”

Here, it is necessary to notice that the male (184) and female (185) locking profiles are interchangeable in between the plate (180) and the fastening side (111) of the housing (110). In this case the thickness of the plate (180) shall have the size allowing fabricating therein a corresponding locking profile, for example, hollows for ball structures, to provide secure of the plate with housing. Any modification derived thereof shall not depart from the scope of the present invention.

By means of the exemplary structure illustrated in any of FIG. 4a-4c, the possibility of intended removal of the housing of the video recorder from the windscreen is provided. In the embodiment illustrated in FIG. 4a, one can demand, in some cases, replacement of the gasket (105) with a new one in view of damage of the former after repetitive cycles of attachment and detachment, in other cases the detachable joining without damage of the gasket (105) is made due to the adhesive properties between the gasket and the windscreen.

Besides this, in another embodiment, the housing (110) may be hingeably secured to the plate (180) such that the housing is able to rotatably switch from a first position, where the fastening side is abutted onto the plate (180), to a second position, which is 90 to 240 degree different from the first position, where the fastening side is not contacted with the plate. The hinge securing may be provided by an axial fixture at edge of the plate for enabling pivoting motion of the housing relatively the plate. The axial fixture may be provided at a left or right edge of the plate or at an upper or a lower edge thereof. Such a construction facilitates movement of the housing (110) from the first position to the second position in which the optical elements (120) enable the video camera to record situation around the camera, for example, the situation of the interior cabin of the vehicle, while the plate remains fastened to the windscreen via the gasket.

By means of providing the housing in the form mentioned above, the enclosed cavity defined by the housing walls is created. In the cavity within the housing, the video camera optical elements (see FIG. 3) are provided. While the field of vision of the video camera in the known video recorders is usually directed away from the housing where the video camera is arranged, without passing through the interior of the recorder housing, according to the present invention, in contrast, the video camera has a field of vision directed inwardly of the housing (110) and is oriented towards the window in the fastening side. Thus, the video camera is arranged in such way that external radiation, for example visible or IR-light passing from the outside the car through the windscreen, gets on the optical elements of the video camera only through the window (119) in the fastening side of the video recorder housing. Thus, the video camera receives the external radiation, generates an image from the radiation by methods known in the art and either records the image in the storage device or, if the recording function is not currently active, transmits the image directly to the display of the video recorder for displaying it to a user, for example, to the car driver in real-time.

The mechanism of mounting the video camera within the housing cavity is not a subject of the present invention. The video camera may be fixedly secured to the back side opposite to the fastening side of the housing, may be fixed within the housing by supports attached to the lateral sides of the housing, etc.

The range of viewing angle or field of vision of the disclosed video recorder (100) depends on the constructive implementation of the optical elements of the video camera and physical dimensions of the housing (110), in particular, the sizes of the window (119) at the fastening side (111). Additionally or separately, the field of vision of the optical elements may be dependent on the relative distance between the front window (119) and the optical element especially in the condition where the fastening side (111) of the housing is partly overlapping with the field of vision of the camera. The viewing angle of the video recorder employed in the present invention may be within the range of ±0.5 to ±89.5 degrees relatively the optical axis of the video camera, preferable within the range of from ±30 to ±70 degrees and the most preferable within the range of from ±35 to ±60 degrees horizontally. The same numerical values may be provided vertically for the viewing angle of the video recorder.

In some embodiments the mounting mechanism provides the video camera with a possibility to be rotated relatively an axis being normal to the optical axis of the video camera, for example, as indicated as arrow “d” in FIG. 5 or FIG. 6. In these embodiments, the camera has a possibility of rotation by means of a handle (135) attached to the camera or its optical elements and extended from the back side of the housing, as illustrated in FIG. 5 (it should be noted that the recorder housing illustrated in FIGS. 5 and 6 is not in the state of being fastening to the windscreen, wherein the mounted state of the housing corresponds to one where the back side (112) is situated from below). The user, for example, the car driver, may grasp the camera handle (135) and pull it down or up thus causing a turn of the camera around the axis normal to the optical axis in order to change up or down, respectively, the direction of the camera's optical axis. The turn of the video camera may be similarly performed by a wheel (137), as indicated in FIG. 6 by the arrow “d.” In a further embodiment, the user has the possibility to move the camera position within the housing along the camera optical axis either toward the windscreen or away from it also by grasp the camera handle (135), as indicated by arrow “c” in FIG. 5. The constructive implementation of the mechanism providing such displacement of the camera along its optical axis should be apparently construed by those skilled in the art.

Further, the camera of the present invention can perceive visible light or infra-red radiation. The type of optical radiation perceptible relies on the sensor of the camera. The image sensor of the disclosed invention is preferably capable of generating image based on optical radiation of visible or infrared light. Apart from that, the optical elements of the present invention are placed within the cavity of the housing (110) to avoid stray optical radiation while conventional vehicle video recording systems generally have the optical elements protruded outwardly from the housing. Although the present invention illustrates (for example, in FIG. 3) that the optical axis of the optical element forms a substantial right angle with the windscreen surface, one skilled in the art shall recognize that the basic principles of the present invention may be applied to like video recorders fastened to the windscreen having optical elements inclined at some angle different from 90° relative to the windscreen. The construction of the video recorder may comprise the video camera optical axis retained approximately horizontally, whereas the windscreen is tilted about horizon, and therefore, the video recorder viewing angle may be restricted from below the optical axis to a greater extent than from above.

The basic advantage of the present video recorder consists in placement of the video camera within the housing autonomously fixed to the windscreen in such way that the field of vision of the video camera is directed to the windscreen through the enclosed, perhaps except the window, cavity within the housing, wherein sidewalls of the housing prevent hitting of light beams from stray light sources onto the video camera lens. In other words, stray light from the sources which are not in the field of vision of the camera, being reflected from the windscreen cannot fall onto the video camera lens. This allows for avoidance of occurrence, for example, parasitic light patches which can lead to distortion of details of the image generated by the video camera.

Video recorder designs according to the present invention provide, besides the advantages specified above, protection against hitting of fog into the housing or against sedimentation on the camera lens of dust or distortion of the images with cigarette smoke which may be present in the car interior, prevents occurrence of moisture in the form of droplets on the lens when temperatures suddenly change, for example, upon the opening of a car door in cold temperature conditions, for example, in winter), etc. Preferably, the cavity is substantially hermetical against smoke, water vapor and/or dust upon mounting the housing onto the windscreen. For example, the smoke of cigarettes inside the vehicle may make its way into the cavity, blocking or deflecting the optical radiation if the cavity was not properly sealed. Likewise, water vapor inside the vehicle may condense onto the lens in the absence of proper sealing at the window. The sealing against smoke, water vapor and/or dust is preferably attained by fastening the video recorder housing as mentioned in the above description. Optionally, the window is further shielded with a transparent material to reinforce the sealing against the external agents. The transparent material preferably has refractive index substantially equal to that of air to ensure the optical radiation passed through thereof free from significant modification.

The inventive video recorder has usual for such devices means for image generating (such as a CCD array), processing (such as a video processor) and storing (such as a memory) intermediate and/or final information, and can also have the communication means for receiving/transmitting instructions or messages transferred by wires or in a wirelessly manner into/from the video recorder, etc.

The power supply for the video recorder may be provided from a built-in battery or external power supply unit connected to the video recorder by wires and energizing all electronic components of the video recorder. If the power is supplied from the built-in battery the housing has a corresponding compartment in which such battery is provided, if the power is supplied from the external power grid the housing should have corresponding sockets for connection it to such power supply.

It is to be understood that the present invention may be embodied in other specific forms and is not limited to the sole embodiment described above. However modification and equivalents of the disclosed concepts such as those which readily occur to one skilled in the art are intended to be included within the scope of the claims which are appended thereto. Although the present invention was described relatively to the car video registers, those skilled in the art can readily recognize that the basic principles of the invention may be applied for surveillance cameras, video monitoring systems operating in gaseous and liquid environments including hostile and reactive environment, in the systems for monitoring technological process, in bathyscaphes, submarines, etc. Therefore, the scope of the present invention should be defined by the accompanied claims but not the particular examples described in the present specification.

What is claimed is:

1. A video recorder removably mounted on a windscreen or a glass pane, comprising:
a housing having sidewalls, including a front side and a back side, forming an enclosed internal cavity within the housing, the front side being substantially flat and having a window through which only an external optical radiation from outside passes into the enclosed internal cavity, wherein the housing is configured for removable attaching onto the windscreen or the glass pane; and
a video camera arranged within the internal enclosed cavity, wherein the optical axis of the video camera lens is oriented toward the window in such way that allows the video camera to acquire the optical radiation passed into the housing solely through the window and falling onto the video camera image sensor, for obtaining an image signal from the acquired external optical radiation.

2. The video recorder according to claim 1, wherein the external optical radiation is at least one of visible light or IR-radiation.

3. The video recorder according to claim 1, wherein the window on the front side of the housing is surrounded by a closed surface of the front side.

4. The video recorder according to claim 1, wherein the housing is fastened to the windscreen by use an adhesive substance applied on the front side of the housing.

5. The video recorder according to claim 1, further comprising a gasket of elastic or resilient material, having an opening substantially coinciding by its form and arrangement with the form and the arrangement of the window in the front side of the video recorder housing, wherein the gasket is attached by a first planar surface to the front side of the housing by a first adhesive substance, wherein the video recorder together with the attached gasket is fastened to the windscreen by a second adhesive substance applied on a second planar surface, opposite to the first planar surface, of the gasket.

6. The video recorder according to claim 5, wherein the first and second adhesive substances are identical.

7. The video recorder according to claim 1, further comprising a gasket of an elastic or resilient material and a firm plate, the gasket and the plate each having an opening substantially coinciding in the form and arrangement with the form and arrangement of the window in the front side of the video recorder housing for matching the openings and the window with each other in the operating state of the video recorder;
wherein the gasket is attached to the plate by a first adhesive substance applied on a first planar surface of the gasket;
wherein the video recorder is fastened to the windscreen through the gasket by a second adhesive substance applied on a second planar surface, opposite to the first planar surface of the gasket, thereby the housing of the video recorder is fastened to the plate in a detachable manner.

8. The video recorder according to claim 7, wherein fastening of the housing in the detachable manner to the plate is implemented by a counterpart locking profile being any one of: (a) latches located along the edges of the plate and fixing the housing to the plate; (b) a male locking profile located on the surface of plate side facing the front side of the video recorder housing and engaging with a female locking profile in the housing front side; (c) at least one ridge on the plate side facing the front side of the housing, extending along the plate surface and slidably engaging with a groove in the housing front side; or (d) a single ridge located on the plate side along a periphery of the plate engaging a reciprocal groove in the housing.

9. A video recorder configured to be removable mounted on a windscreen or a glass pane, comprising:
a housing having sidewalls, including a front side and a back side, forming an enclosed internal cavity within the housing, the housing front side being substantially flat and having a window through which only an optical radiation from outside passes into the enclosed internal cavity;
a plate having an opening substantially coinciding in its form and arrangement with the form and arrangement of the window in the front side of the housing, and having a male locking profile for interlocking with a female locking profile on the housing for abutting the plate onto the front side of the housing, the plate having an axial fixture provided at its edge for enabling pivoting motion of the housing relative to the plate,
a gasket for fastening by a first adhesive, applied onto a first planar surface of the gasket, to the plate and fastening by a second adhesive, applied onto a second planar surface of the gasket, to the windscreen or the glass pane, the gasket having an opening substantially coinciding in its form and arrangement with a form and arrangement of the window in the front side of the housing; and
a video camera arranged within the internal enclosed cavity, wherein an optical axis of video camera lens is oriented toward the window in such way that allows the video camera to acquire external optical radiation passed into the housing solely through the window and falling onto the video camera image sensor, for obtaining an image signal from the acquired external optical radiation.

10. The video recorder according to claim 9, wherein the first and second adhesive substances are identical.

11. The video recorder according to claim 9, wherein the external optical radiation is at least one of visible light or IR-radiation.
